(19) United States
(12) Patent Application Publication
(10) Pub. No.: US 2010/0199719 A1
(43) Pub. Date: Aug. 12, 2010

(54) ARCHITECTURAL GLASS BLOCK WITH A FORMED SLOT AND METHOD OF MAKING SAME

(75) Inventors: Russell FOX, Greensburg, PA (US); Peter R. Atherton, Export, PA (US); Michael R. James, Eldred, PA (US); Richard Y. Greene, Port Allegany, PA (US)

Correspondence Address: REED SMITH LLP, P.O. BOX 488, PITTSBURGH, PA, 15230-0488, US

(73) Assignee: PITTSBURGH CORNING CORPORATION, Pittsburgh, PA (US)

(21) Appl. No.: 12/763,542

(22) Filed: Apr. 20, 2010

Related U.S. Application Data
(62) Division of application No. 11/854,394, filed on Sep. 12, 2007, now abandoned.
(60) Provisional application No. 60/825,326, filed on Sep. 12, 2006.

(51) Int. Cl. C03B 19/02

(52) U.S. Cl. 65/48

(57) ABSTRACT

A glass block, and method for making a glass block, having one or more formed slots on one or more edge faces of the block. The slots are formed during the molten state of the glass formation to maintain the mechanical integrity of the glass structure in architectural applications. The glass block may have an insert placed inside by way of the formed slot, the insert having performance and/or decorative properties.

### PRIOR APPLICATION

This application claims priority from U.S. Application No. 60/825,326, filed Sep. 12, 2006, entitled “Architectural Glass Block With A Formed Slot And Method Of Making Same”.

### BACKGROUND OF THE INVENTION

1. Field of the Invention

The present invention relates to architectural glass blocks and methods of making such blocks. More particularly, the invention relates to a glass block having one or more formed slots on one or more edge faces of the block. The slots are formed during the molten state of the glass formation to maintain the mechanical integrity of the structure in architectural applications.

2. Background of the Invention

Glass blocks may be used instead of bricks, plaster, wood or other materials in the construction of walls, partitions and windows. Aside from the aesthetic advantages that the glass blocks may provide over other materials, the glass blocks may be preferable because they are transparent and allow light to filter through, thereby permitting viewing through the wall, or creating a brighter room or office space.

In recent history, glass blocks have lost some consumer demand as a construction material due to certain limitations pertaining to performance and design properties. As the world becomes more focused on energy conservation and safety as well as new design, glass window and acrylic block industries have engineered enhanced properties into their products; such properties include energy conservation, fire resistance, and new aesthetic choices. While glass block performance lags behind plate glass and, in some cases, acrylic block, for many reasons, the driving force for a performance and design glass block increases with newly enforced energy codes and the public's growing awareness of safety needs and design options. The purpose of the slotted block described herein is to enable the introduction of materials inside the block that will enable the block to achieve desired performance and aesthetic characteristics.

Addressing this lagging glass block innovation, previous patents describe how to enable the insertion of a material into a glass block. While these patents have achieved some new performance characteristics, they have yet to enable the glass block to provide reliable performance as an architectural material. Two particular methods are described in prior patents. U.S. Pat. No. 5,160,566, issued to Ashby, describes the formation of a slot in a pre-made glass block using a saw. However, such a cut in a pre-made glass block introduces planar flaws, such as stress lines or faults, into the rigid glass, thereby causing imminent crack propagation throughout the entire block. This is not only an unsatisfactory architectural element in terms of function and appearance, but also a significant safety hazard. U.S. Pat. No. 6,553,733, issued to Pittsburgh Corning Corporation, describes the formation of two block halves, between which a material can be placed and sealed in a unit. However, this design is not always a sufficient performance construction material because of the inherent potential, on all block sides, for structural weakness due to seal failure.

As the prior art described has attempted to engineer a solution to the problem of providing a discontinuity in the glass that is mechanically sound, other art has abandoned the use of glass as a construction block material. Such can be seen in U.S. Pat. No. 6,260,317 and U.S. Pat. No. 6,802,162, both to Fisher, which disclose acrylic or other resinous (as opposed to glass) construction blocks. Therefore, to those interested in the material properties of glass block, there is a dire need for a glass block formed with the capability to assume performance and design properties while meeting architectural requirements such as weathering. To accomplish this, the architectural block must have good mechanical strength properties, a slot to fit one or more performance or design materials, no planar defects, and optimized dimensionality for safety and utility. The present invention addresses those outstanding needs.

### SUMMARY OF THE INVENTION

The architectural block with one or more formed slots of the present invention creates a new world of performance and design capabilities in the glass block industry. More specifically, the present invention enables a performance or design insert to be placed inside a glass block while maintaining the glass's structural strength as a building component. The present invention eliminates both the problem of crack propagation from sawing a slot in a glass block and the problem of poor integrity of the seal between two solid halves of a glass block. Additionally, the present invention addresses the problem of creating a uniform slot across the edge face, and possibly extending down the sides, of a glass block.

The architectural glass block with a formed slot is comprised of a hollow, cuboidal (box-like) glass structure with one or more slots on one or more edge faces of the block. The slot has no cracks on the surrounding perimeter of glass because it is formed while the glass structure is in its soft molten state. Also, to optimize the glass block's strength, the slot has optimal combinations of the following characteristics, all of which are controlled during the glass forming process: slot width, thickness of glass around the perimeter, linearity, and dimensionality around the edges.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows the slotted glass block of the present invention;

FIG. 2 shows two halves of the slotted glass block of the present invention prior to being connected together;

FIG. 3 shows a side view of the slotted glass block of the present invention;

FIG. 4 shows a performance or decorative insert being inserted into the slotted glass block; and

FIG. 5 shows a performance or decorative insert sealed inside the slotted glass block.

### DETAILED DESCRIPTION OF PREFERRED EMBODIMENTS OF THE INVENTION

It is to be understood that the figures and descriptions of the present invention have been simplified to illustrate elements that are relevant for a clear understanding of the invention. The detailed description will be provided hereinbelow with reference to the accompanying drawings.

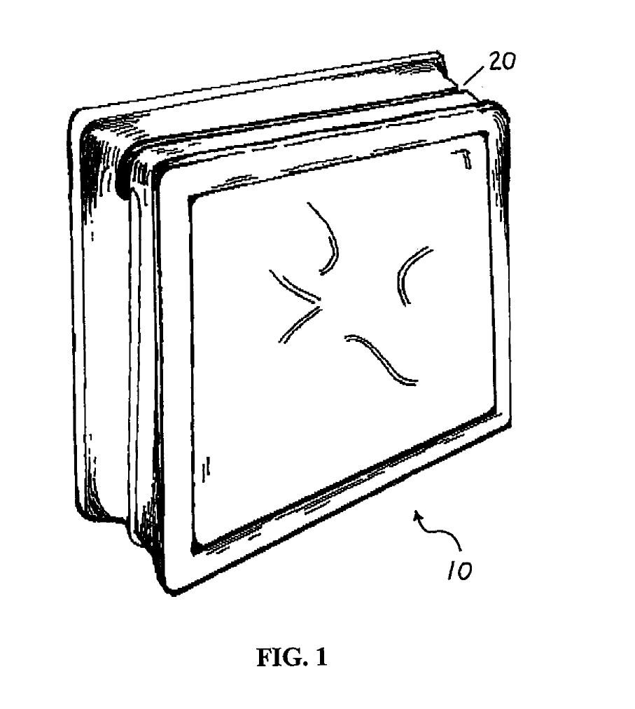

In one embodiment, as shown in FIG. 1, the architectural glass block with a formed slot comprises a hollow, cuboidal (box-like) glass structure 10 with one or more slots 20 on one or more edge faces of the block. It is expressly understood that the glass block 10 can be constructed in a shape other than square or rectangular, and having other than four sides, in keeping within the scope and spirit of the present invention. The outer surface of the glass block can be generally smooth, or can have any appropriate structure for joining the glass block to other glass blocks to create a wall or panel of blocks.

The formation of the glass block 10 begins when a glass mixture is heated to a temperature ranging preferably from about 1100 to 1200 degrees Celsius. This temperature range is a proper range for the desired glass viscosity necessary for the formation of a preferred embodiment; while the molten mixture must be viscous enough to maintain the slot's shape during pressing, too much or too little viscosity may cause the process to fail in several areas.

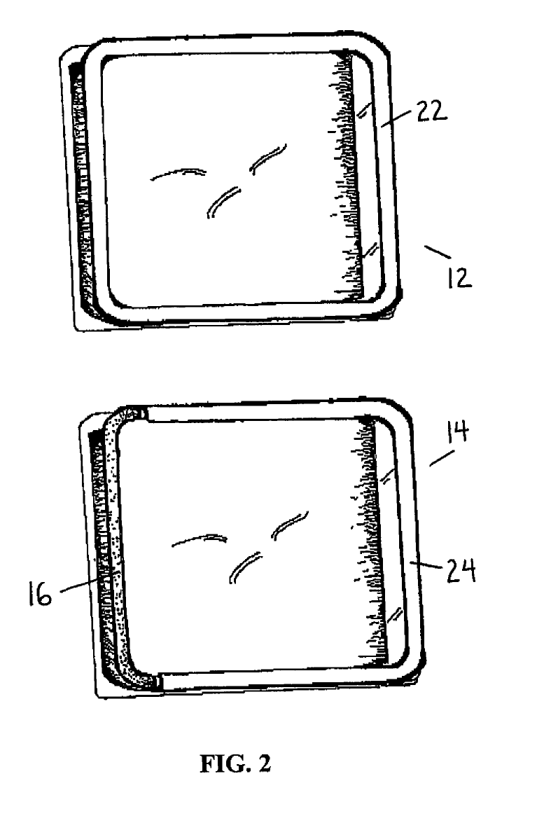

Referring to FIG. 2, molten halves 12 and 14 of the glass structure 10 are initially shaped when the glass mixture is transferred to a mold and shell combination, mounted on a glass press, as is known to one of skill in the art. A preferred glass structure preferably utilizes a mold and shell combination in which the shell has a relief in the shape of the desired slot 20 and the mold does not. This preferred combination will leave a void 16 in one half 14 of the block 10 when the block halves 12 and 14 are pressed, maintaining the block's seam that will later act as a shelf for an insert, as described below.

The inner side of each glass half 12 and 14 is initially shaped when the mold and shell are moved under a pressing head, as known to those skilled in the art. The pressing head utilizes a plunger to form the inside of each block half 12 and 14. A preferred shell is designed such that the slot formation does not interfere with the angle of the plunger, allowing the same plunger as regular glass block to be used in creating a glass block with a formed slot. During the plunging process, the mold and shell combination shapes the slot 20 by restricting the glass flow around the shell's relief at tight clearance tolerances between the shell and the plunger. Removing the heat from the glass, the plunger is held in the glass for a sufficient amount of time to stabilize the molten glass flow. The halves 12 and 14 of the glass structure 10 are further stabilized in one or more cooling stations where a gas or liquid is used to cool the glass, mold, and shell. It is known in the art that, in order to compensate for glass flow, the geometry of the slot tooling may be different than the final product.

The body of the glass structure 10 is fully formed when the two halves 12 and 14 of the block 10 are removed from the mold and shell combination and welded. The two halves 12 and 14 are welded such that the open sides of the block halves are facing each other and their sealing edges 22 and 24 are lined up. The body of the block 10 is then heated to allow the sealing edges 22 and 24 to join, during which the burner pressure is controlled, preferably varying by no more than 10%, to maintain the slot's desired shape and uniformity, and to minimize inconsistencies such as the sagging around the perimeter of the slot. Additionally, in maintaining the slot's desired shape, the seal temperature may be adjusted in accordance with the width of the block; the shorter the width, the lower the temperature may be adjusted. The body of the glass block 10 assumes its final shape when the two half-blocks 12 and 14 are squeezed together at a restricted distance, such that the desired slot width is formed at the current procedure's temperature and pressure. The distance that the block halves are squeezed together is generally less than a normal block's distance. This decrease is accomplished by raising the donut inside a range of sixty thousandths of an inch to three hundred thousandths of an inch.

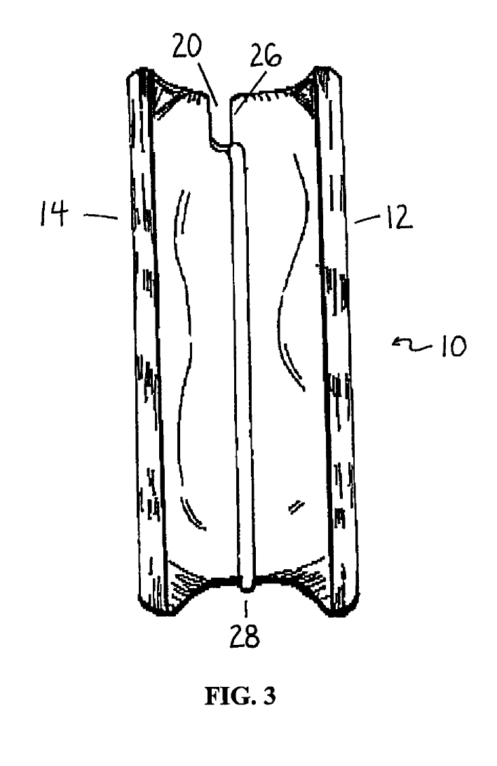

Referring to FIGS. 3-5, in a preferred embodiment the glass block 10 of the present invention may have a slot 20 that is offset from the center of the block 10. In one such preferred embodiment, the slot is a specific width of 0.148 inches plus or minus 0.03125 inches, allowing for a 0.09375 inch insert clearance. This dimension minimizes the moisture vapor transfer over the slot 20 by minimizing the air gap between the insert 18 and the glass block 10. Other slot sizes within the scope of the invention would be apparent to those skilled in the art, depending on factors such as the nature of the insert 18 or the size of the block 10. Also in this preferred embodiment, the slot 20 is off center of the block 10 by one eighth of an inch, creating a shelf 26 alongside the seam 28 of the block 10. This shelf acts as a locating barrier for the rigid insert to remain in place. The long sides of the slot should remain parallel to allow for the insert's introduction and parallel alignment to the block's seam.

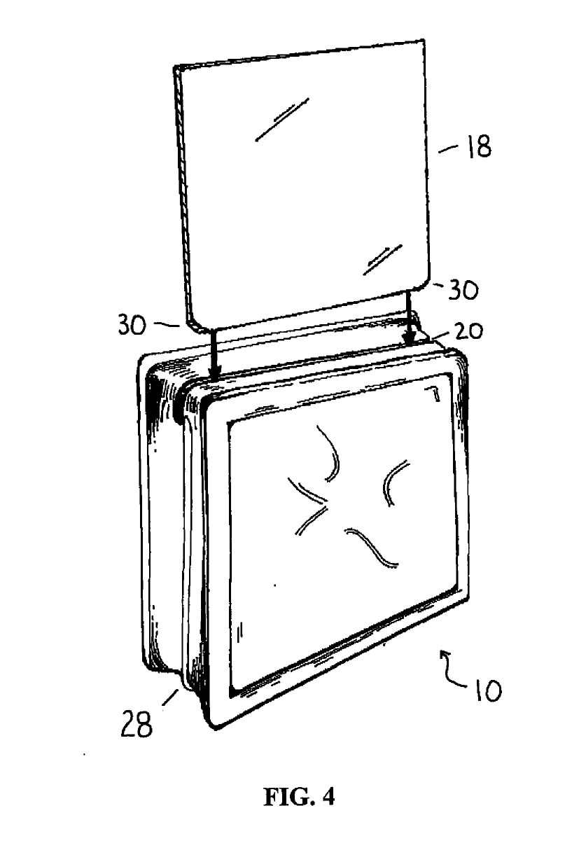

Referring to FIG. 4, in a preferred embodiment, the glass block 10 of the present invention may have an insert 18 placed inside by way of the formed slot 20. This insert 18 has an optimal shape to fit into the block 10. For example, a square block may have a square insert. One preferred insert is rigid glass that spans the entire height and width of the block 10. This preferred insert has beveled corners 30, which allows the insert to rest on the bottom of the block, and not just on the bottom corners that have a 0.125 inch inside diameter. This inner diameter would otherwise cause the insert to be raised noticeably at one eighth of an inch from the bottom of the block. Therefore, in a preferred embodiment, the insert's bottom edges are clipped at a 45 degree angle, beginning at 1/32 of an inch from the corner. In another preferred embodiment, an insert may have rounded clipped edges, cut by a radius clipper. Restated, these preferred inserts fit more securely at the bottom of the block, prevent point loading at the corners of the inserts, and provide a better aesthetic quality to block.

The insert 18 preferably has performance and/or decorative properties. For example, the insert 18 may be colored to change the block's appearance and provide shading. One preferred insert has a transparent coating that improves the glass block's thermal insulation (U-Value) and solar heat gain coefficient (SHGC). Another preferred insert is a mylar insert with the same coating that improves the U-Value and SHGC. Other performance properties include, but are not limited to: UV absorption, solar heat gain reduction, fire protection, increased ballistics properties and increased privacy via opacity manipulation. Likewise, the insert may be made out of one or any combination of materials including, but not limited to, glass, coated glass, polymer, metal, composite, and ceramic, depending on the function that the insert is intended to serve. In addition to the insert 18, an inert gas such as argon may be placed inside the block to improve the block's energy characteristics.

As shown in FIG. 3, by offsetting the slot 20 from the center of the block 10, a support structure or shelf 26 is created inside the block where the two block halves 12 and 14 meet. This shelf 26 provides a support on which the insert 18 can rest or be stabilized.

The insert 18 may be stabilized at the bottom inside of the block to minimize the insert's rattling inside the block. This stability may be accomplished by applying an adhesive to the bottom edge, side edges, and/or corners of the insert. This adhesive may have a silicone base, polyurethane base, or other. Other ways in which the insert may be stabilized include, but are not limited to, applying a tape to the bottom of the insert, inserting a formed polymer pieces on the bottom of the insert to lessen the glass on glass contact, forming the glass block with one or more slots to secure the insert at the bottom or edges of the block, or forming the glass block with internal protrusions that lessen the insert's range of motion.

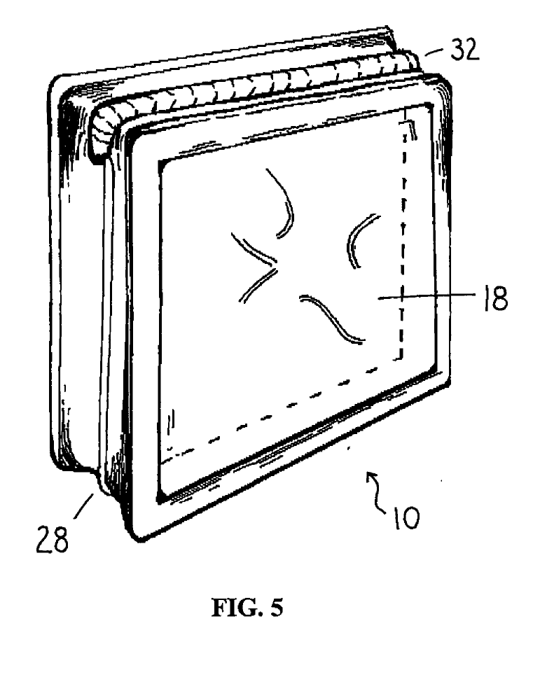

As shown in FIG. 5, in some embodiments, the glass block 10 may have a sealant 32 overlaying or filling its slot 20. The sealant 32 may reduce vapor transmission into the block as well as increase the overall structural strength of the glass block. Forming a rigid or gummy seal, the sealant 32 may be made of any material that would perform as described. The sealant 32 may be, but is not limited to, one of the following materials: a desiccant matrix, a glass solder, a silicone-based mixture, or a preformed polymer such as polyurethane.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

1-22. (canceled)

23. A method of making a slotted glass block comprising the steps of:
heating a glass mixture to a temperature to obtain a desired viscosity;
transferring said heated glass mixture to a mold and shell combination, wherein the shell has a relief that will produce the desired shape of a slot;
forming two glass block halves with the mold and shell combination;
fusing the two glass block halves together to form a single block having a slot; and
squeezing the two block halves together to form a desired width of the slot.

24. The method of claim 23, further comprising the step of placing an insert inside the slotted glass block via the slot.
